(19) United States
(12) Patent Application Publication
(10) Pub. No.: US 2012/0243274 A1
(43) Pub. Date: Sep. 27, 2012

(54) Control Methods for Parallel-Connected Power Converters

(75) Inventors: Chunmei Feng, Cheshire (GB); Veimar Yobany Moreno-Castañeda, Cheshire (GB); Richard Stuart Webb, Staffordshire (GB); Jeremy Stephen Prevost Knight, Staffordshire (GB)

(73) Assignee: CONVERTEAM TECHNOLOGY LTD., Warwickshire (UK)

(21) Appl. No.: 13/380,082

(22) PCT Filed: Jun. 29, 2010
(86) PCT No.: PCT/EP10/03846

§ 371 Date: Mar. 7, 2012

(30) Foreign Application Priority Data
Jul. 2, 2009 (EP) 09251710.1

(51) Int. Cl. H02M 7/08

(52) U.S. Cl. 363/69

(57) ABSTRACT

A method is described for controlling a plurality of power converters 1, 2 connected in parallel between an ac arrangement 12 and a common dc link 16, each of the power converters 1, 2 operating in accordance with a pulse width modulation (PWM) strategy and having an independently variable dc link reference voltage. The method comprises modifying an output voltage droop characteristic of at least one of the plurality of parallel-connected power converters 1, 2 by varying the dc link reference voltage of the at least one power converter 1, 2 based on the output current of the at least one power converter 1, 2 and the average of the output currents of the plurality of power converters 1, 2.

### FIELD OF THE INVENTION

The present invention relates generally to methods for controlling a plurality of parallel-connected power converters. More particularly, the present invention relates to methods for controlling a plurality of power converters connected in parallel between an ac arrangement and a common dc link. Embodiments of the present invention relate to methods for controlling a plurality of parallel-connected power converters operating with a pulse width modulation (PWM) strategy and which can be used to interface a motor requiring variable voltage at variable frequency to a three-phase supply network (ac busbar) at nominally fixed voltage and frequency. The methods can also be used for controlling a plurality of parallel-connected power converters operating with a PWM strategy that are used to interface generators providing variable voltage at variable frequency to a power grid or to a supply network at nominally fixed voltage and frequency.

### BACKGROUND ART

As mentioned above, power converters can be used in motoring applications to convert the nominally fixed voltage and frequency supplied by a three-phase supply network into variable voltage and frequency to provide suitable control for a variable speed ac motor.

Typically, a power converter in the form of a network bridge and operating as an active rectifier supplies power to a dc link. The dc output voltage of the network bridge is fed to the dc terminals of a power converter in the form of a machine bridge and operating as an active inverter. The ac output voltage of the machine bridge is finally supplied to a variable speed ac motor.

Power converters can also be used in electricity generation applications in which wind energy is converted into electrical energy by using a wind turbine to drive the rotor of a generator, either directly or indirectly by means of a gearbox. The ac frequency that is developed at the stator terminals of the generator (the stator voltage) is directly proportional to the speed of rotation of the rotor. The voltage at the generator terminals also varies as a function of speed and, depending on the particular type of generator, on the flux level.

For optimum energy capture, the speed of rotation of the output shaft of the wind turbine will vary according to the speed of the wind driving the turbine blades. To limit the energy capture at high wind speeds, the speed of rotation of the output shaft is controlled by altering the pitch of the turbine blades. Suitably configured power converters can be used to connect the variable voltage and frequency of the generator to the nominally fixed voltage and frequency of the supply network.

Typically, a power converter in the form of a generator bridge and operating as an active rectifier is used to supply power from the generator to a dc link. The dc output voltage of the generator bridge is fed to the dc terminals of a power converter in the form of a network bridge and operating as an active inverter. The ac output voltage of the network bridge is filtered and supplied to the nominally fixed frequency supply network via a step-up transformer.

In some applications employing three-phase power supplies, such as those outlined above, it can be desirable to connect several power converters in parallel. For example, where an element of redundancy is required to ensure that a reliable source of power can be provided in the event of failure of a power converter, the required redundancy can be achieved by connecting several power converters in parallel. It can also be desirable to connect several power converters in parallel in applications where high performance/efficiency and/or high power output is/are required.

A number of potential difficulties can, however, arise when power converters are connected in parallel and although strategies for mitigating the effects of those difficulties are known, the existing strategies are not ideal.

When power converters are connected in parallel, it is necessary to provide for suitable current sharing between individual power converters to optimise the power distribution amongst the power converters. This can be achieved by controlling the output voltage droop characteristics of the power converters, and various voltage droop control methods are known. Whilst known voltage droop control methods may be able to provide for suitable current sharing between parallel-connected power converters, this is typically at the expense of voltage regulation, with the range in output voltage variation between the power converters being substantially increased.

In the event that there is any desynchronisation between the PWM strategies of the power converters, and in particular the PWM command signals, it is possible for a circulating current to flow around the loop formed by the power converters. The presence of a circulating current is undesirable because it does not process useful power and places extra stress on the power converters. The circulating current can, in fact, be destructive if it is allowed to become excessively large.

One known solution for eliminating circulating current amongst parallel-connected power converters is to install an isolation transformer in the three-phase supply path of all but one of the power converters. The isolation transformer electrically separates the input circuits, whilst allowing the transmission of ac signal/power. Isolation transformers are, however, bulky and very expensive and it would be preferable not to have to use them.

There is, therefore, a need for improved methods for controlling a plurality of parallel-connected power converters which may address some or all of the difficulties associated with known parallel-connected power converters, such as the difficulties outlined above.

### SUMMARY OF THE INVENTION

According to one aspect of the present invention, there is provided a method for controlling a plurality of power converters connected in parallel between an ac arrangement and a common dc link, each of the power converters operating in accordance with a pulse width modulation (PWM) strategy and having an independently variable dc link reference voltage, the method comprising modifying an output voltage droop characteristic of at least one of the plurality of parallel-connected power converters by varying the dc link reference voltage of the at least one power converter based on the output current of the at least one power converter and the average of the output currents of the plurality of power converters.

The method enables the current sharing performance of the power converters to be improved and at the same time enables the voltage regulation performance to be improved. This is in contrast to some known voltage droop control methods in which the voltage regulation performance is adversely affected as current sharing performance is improved.

The method may comprise modifying the output voltage droop characteristic of each of the plurality of parallel-connected power converters by varying the dc link reference voltage of each power converter based on the output current of each respective power converter and the average of the output currents of the plurality of power converters. Such an implementation provides for even greater control over the current sharing and voltage regulation performance of the power converters.

For example, where at least first and second power converters are connected in parallel, the method may comprise modifying the output voltage droop characteristic of the first power converter by decreasing the dc link reference voltage of the first power converter based on the output current of the first power converter and the average of the output currents of the plurality of power converters and may comprise modifying the output voltage droop characteristic of the second power converter by increasing the dc link reference voltage of the second power converter based on the output current of the second power converter and the average of the output currents of the plurality of power converters.

The method may comprise continuously determining the output currents of the plurality of power converters, thus permitting the average of the output currents of the plurality of parallel-connected power converters to be determined continuously, in real-time. This may permit the dc link reference voltage of the or each power converter to be actively varied based on the continuous determinations of the output currents and the average of the output currents. The output voltage droop characteristic of the or each power converter can thus advantageously be actively modified.

The method may comprise varying the dc link reference voltage of the or each power converter based on the error between the average of the output currents of the plurality of power converters and the rms output current of the or each respective power converter.

The error between the average of the output currents of the plurality of power converters and the rms output current of the or each respective power converter may be determined by subtracting the rms output current of the or each respective power converter from the average of the output currents of the plurality of power converters.

In some embodiments, the method may comprise transforming the rms output current of the or each power converter and the average of the output currents of the plurality of power converters from the stationary reference frame into the rotating reference frame prior to performing said subtraction step to determine the error between the currents. In this case, the dc link reference voltage of the or each power converter may be varied based on the error between the transformed value of the rms output current of the or each respective power converter and the transformed value of the average of the output currents of the plurality of power converters.

The output voltage droop characteristic of the or each power converter may be defined by a droop rate and a droop sign applied to the droop rate. The droop sign may be either positive or negative. The step of controlling the output voltage droop characteristic of at least one of the plurality of power converters may further comprise determining the droop sign applied to the droop rate and more particularly may comprise determining whether the droop sign, and hence the droop rate, is positive or negative. The parallel-connected power converters can thus be used when power is either supplied from the ac arrangement to the common dc link (for example in motoring applications) or from the common dc link to the ac arrangement (for example in power generation applications).

The step of determining the droop sign may comprise determining the direction of current flow through the common dc link. The direction of current flow through the common dc link is indicative of the power flow direction and thus enables the correct droop sign, positive or negative, to be correctly determined.

As indicated above, desynchronisation between parallel-connected power converters can cause a circulating current to flow between the power converters. The method for controlling the plurality of parallel-connected power converters may thus additionally comprise synchronising the power converters by providing each of the parallel-connected power converters with a synchronisation signal. The synchronisation signal enables the PWM switching strategies of the power converters to be synchronised.

The power converters may be connected together to define a cascaded array comprising a master power converter and one or more slave power converters. In such a cascaded array, the synchronisation signals may be passed between the power converters in the array whilst each of the power converters in the array is still connected in parallel between the ac arrangement and the common dc link. The period of the synchronisation signal received by each power converter in the array may be different and may be indicative of the position of that power converter in the array.

The power converter in the array that is the first to come on-line may assume a role as a “master” power converter and may take a position as the first power converter in the array. In the first instance, the decision to assume the role as the “master” power converter may be made because of the absence or lack of any synchronisation signal being received by that power converter. Any power converter that receives a synchronisation signal when it comes on-line will preferably assume a role as a “slave” power converter. Any “slave” power converter that fails to receive a synchronisation signal for any reason (e.g. the immediately preceding power converter in the array goes off-line or the synchronisation signal is disrupted) may assume a role as a “master” power converter.

The synchronisation signals may be transmitted from one power converter to another power converter by any suitable means. For example, the synchronisation signals may be a wireless signal such as a radio frequency (RF) signal, for example, or an electrical or optical signal transmitted through an electrical cable or an optical fibre.

The synchronisation of the parallel-connected power converters using synchronisation signals minimises any desynchronisation (i.e. phase shift) between the PWM switching strategies of the parallel-connected power converters and thereby minimises or eliminates any unwanted circulating currents flowing between the power converters.

The PWM strategy of each power converter may be defined by an independent voltage carrier signal and an independently controllable modulating sinusoidal voltage signal which are used to generate a PWM command signal for each PWM strategy. The voltage carrier signals of the PWM strategies may have the same switching period and any desynchronisation of the PWM command signals may cause an unwanted circulating current to flow between the power converters. Despite the use of the synchronisation signals mentioned above to synchronise the power converters, a circulating current may still be present when certain faults, such as an earth fault, occur.

Accordingly, the method for controlling the plurality of parallel-connected power converters may additionally comprise providing the independently controllable modulating sinusoidal voltage signal of the PWM strategy of at least one of the power converters with a dc voltage offset to modify the PWM command signal of the at least one power converter and thereby increase the synchronisation of the PWM command signals so that the magnitude of any unwanted circulating current is reduced. The method may possibly comprise providing the independently controllable modulating sinusoidal voltage signal of all but one of the power converters with a dc voltage offset to modify the PWM command signals of all but one of those power converters and thereby increase the synchronisation of the PWM command signals of all of the power converters so that the magnitude of any unwanted circulating current is reduced.

This dc voltage offset methodology, which is particularly intended to reduce or eliminate unwanted zero sequence circulating current, is typically implemented using a proportional-integral-derivative (PID) controller and is fully described in the Applicant's European patent application having the same filing date as the present application and entitled ‘Control methods for the synchronisation of parallel-connected power converters operating in accordance with a pulse width modulation (PWM) strategy’.

According to an embodiment of the present invention, there is provided a method for controlling a plurality of power converters connected in parallel between an ac arrangement and a common dc link, each of the power converters operating in accordance with a pulse width modulation (PWM) strategy and having an independently variable dc link reference voltage, the PWM strategy of each power converter being defined by an independent voltage carrier signal and an independently controllable modulating sinusoidal voltage signal which are used to generate a PWM command signal for each PWM strategy, wherein the voltage carrier signals of the PWM strategies have the same switching period and wherein any desynchronisation of the PWM command signals causes an unwanted circulating current to flow between the power converters, the method comprising:
(i) modifying an output voltage droop characteristic of at least one of the plurality of parallel-connected power converters by varying the dc link reference voltage of the at least one power converter based on the output current of the at least one power converter and the average of the output currents of the plurality of power converters;
(ii) synchronising the power converters by providing each of the parallel-connected power converters with a synchronisation signal;
(iii) providing the independently controllable modulating sinusoidal voltage signal of the PWM strategy of at least one of the power converters with a dc voltage offset to modify the PWM command signal of the at least one power converter and thereby increase the synchronisation of the PWM command signals so that the magnitude of any unwanted circulating current is reduced.

The method for controlling the plurality of power converters according to this embodiment may include one or more of the features or method steps defined above.

The method according to this embodiment may be particularly advantageous since it (i) provides for current sharing between the parallel-connected power converters; (ii) reduces or eliminates desynchronisation (i.e. phase shift) of the PWM command signals of the PWM strategies of the power converters; and (iii) reduces or eliminates zero sequence circulating current which may arise due to unbalanced loads and/or some faults.

According to another aspect of the present invention, there is provided a plurality of power converters connected in parallel between an ac arrangement and a common dc link, each of the power converters operating in accordance with a pulse width modulation (PWM) strategy and having an independently variable dc link reference voltage, at least one of the power converters including a droop controller for modifying an output voltage droop characteristic of the power converter, wherein the droop controller is operable to modify the output voltage droop characteristic by varying the dc link reference voltage of the at least one power converter based on the output current of the at least one power converter and the average of the output currents of the plurality of power converters.

Each of the plurality of parallel-connected power converters may include a droop controller. Each droop controller may be operable to modify the output voltage droop characteristic of its respective power converter by varying the dc link reference voltage of its respective power converter based on the output current of its respective power converter and the average of the output currents of the plurality of power converters.

The or each droop controller may be operable to actively vary the dc link reference voltage of its respective power converter based on continuous determinations of both the output current of its respective power converter and the average of the output currents of the plurality of power converters.

The or each droop controller may be operable to vary the dc link reference voltage of its respective power converter by determining the error between the average of the output currents of the plurality of power converters and the rms output current of its respective power converter.

The or each droop controller may be operable to determine the error between the average of the output currents of the plurality of power converters and the rms output current of its respective power converter by subtracting the rms output current of its respective power converter from the average of the output currents.

The or each droop controller may be operable to control the output voltage droop characteristic of its respective power converter by determining the droop sign applied to the droop rate, and more particularly by determining whether the droop sign, and hence the droop rate, is positive or negative. As indicated above, such an implementation enables the power converters to be used when power is either supplied from the ac arrangement to the common dc link or from the common dc link to the ac arrangement (i.e. in motoring or power generation applications).

The or each droop controller may be operable to determine the droop sign applied to the droop rate of its respective power converter by determining the direction of current flow through the common dc link.

The power converters may be operable as active rectifiers or may be operable as active inverters.

When the plurality of parallel-connected power converters operate as active rectifiers, the ac arrangement may comprise a common ac source which supplies power via the plurality of parallel-connected power converters to the common dc link. The plurality of active rectifiers may thus be used to interface a motor to a supply network or busbar. The ac arrangement may alternatively comprise a plurality of individual ac sources, each of which is associated with one of the parallel-connected power converters and which together supply power via the plurality of parallel-connected power converters to the common dc link.

When the plurality of parallel-connected power converters operate as active inverters, the common dc link may supply power via the plurality of parallel-connected power converters to the ac arrangement, which may be a common ac load or a plurality of individual ac loads. The plurality of active inverters may thus be used to interface a generator to a supply network.

In some embodiments, the ac arrangement may comprise a plurality of individual ac sources and ac loads and the common dc link may comprise a common dc ring bus. Each of the plurality of power converters may be connected to an ac source or an ac load and in parallel to the common dc ring bus. Each power converter that is connected to an ac source may operate as an active rectifier to supply power from the respective ac source to the common dc ring bus. Each power converter that is connected to an ac load may operate as an active inverter to supply power from the common dc ring bus to the respective ac load. It will, thus, be clear that some of the plurality of parallel-connected power converters may operate as active rectifiers whilst the remainder of the plurality of parallel-connected power converters may operate as active inverters.

Each of the plurality of parallel-connected power converters may include a controller for receiving and transmitting a synchronisation signal. The synchronisation signal permits the PWM switching strategies of the power converters to be synchronised, thereby avoiding phase shift between the PWM switching strategies and resultant circulating currents.

As indicated above, the power converters may be connected together to define a cascaded array comprising a master power converter and one or more slave power converters. Each controller may be operable to determine the position of its associated power converter in the array based on the period of the received synchronisation signal.

The PWM strategy of each power converter may be defined by an independent voltage carrier signal and an independently controllable modulating sinusoidal voltage signal which are used to generate a PWM command signal for each PWM strategy. The voltage carrier signals of the PWM strategies may have the same switching period and desynchronisation of the PWM command signals may cause an unwanted circulating current to flow between the power converters. Accordingly, at least one of the plurality of parallel-connected power converters may include a controller which is selectively operable to provide the independently controllable modulating sinusoidal voltage signal of the PWM strategy of the at least one power converter with a dc voltage offset to modify the PWM command signal of the at least one power converter. This may increase the synchronisation of the PWM command signals so that the magnitude of any unwanted circulating current is reduced.

According to a further aspect of the present invention, there is provided a method for controlling a plurality of power converters connected in parallel between an ac arrangement and a common dc link, each of the power converters operating in accordance with a pulse width modulation (PWM) strategy and having an output voltage droop characteristic defined by a droop rate and a droop sign applied to the droop rate, wherein the method comprises controlling the output voltage droop characteristic of at least one of the plurality of power converters by determining the droop sign applied to the droop rate, the droop sign being determined based on the direction of current flow through the common dc link.

The method for controlling the plurality of power converters according to this further aspect of the present invention may include one or more of the method steps or features defined above.

The droop sign may be positive or negative. The direction of current flow through the common dc link is indicative of the power flow direction and thus enables the correct droop sign, positive or negative, to be correctly determined. The step of controlling the output voltage droop characteristic of at least one of the plurality of power converters may thus comprise determining whether the droop sign is positive or negative based on the direction of current flow through the common dc link.

The parallel-connected power converters can thus be used when power is either supplied from the ac arrangement to the common dc link (for example in motoring applications) or from the common dc link to the ac arrangement (for example in power generation applications).

### DRAWINGS

FIG. 1 is a schematic illustration of a power conversion system in which several power converters are connected in parallel between a common ac source and a common dc link;

FIG. 2 is a schematic illustration of the load regulation characteristics of the parallel-connected power converters of FIG. 1;

FIG. 3 is a schematic illustration of modified load regulation characteristics of the parallel-connected power converters of FIG. 1 in which the output voltage droop characteristics of both power converters have been modified by varying the dc link reference voltages of both power converters;

FIG. 4 is a schematic illustration of one embodiment of a control methodology for controlling the operation of at least one of a plurality of parallel-connected power converters; and

FIG. 5 is a schematic illustration of one implementation of a cascaded array of controllers which operate to synchronise a cascaded array of parallel-connected power converters.

### DETAILED DESCRIPTION OF EMBODIMENTS OF THE INVENTION

Embodiments of the present invention will now be described by way of example only and with reference to the accompanying drawings.

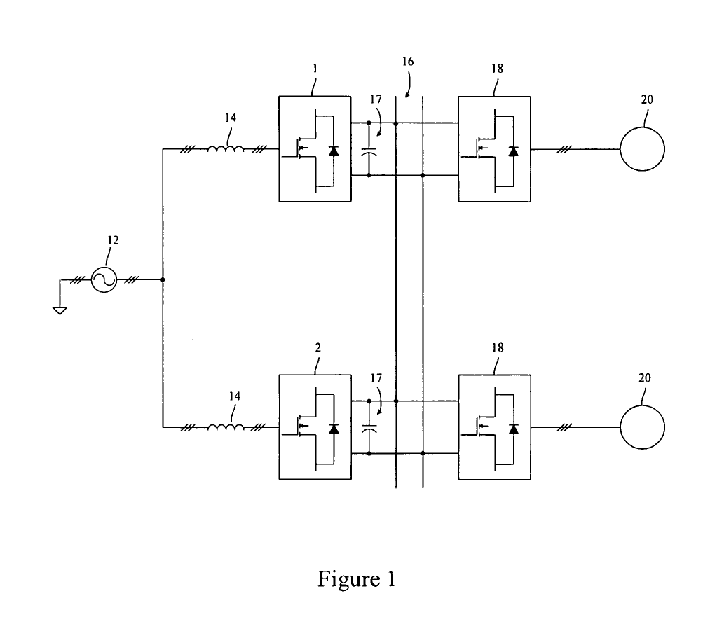

FIG. 1 is a schematic illustration showing a plurality of power converters 1, 2 connected in parallel. In the illustrated arrangement, the power converters 1, 2 operate as active rectifiers and have ac terminals connected to a common three phase ac source 12 via line reactors 14 and dc terminals connected to a common dc link 16, via dc link capacitors 17, to which power is supplied. Although two power converters 1, 2 are illustrated in FIG. 1, it should be understood that any suitable number of power converters may be provided and that this may depend, amongst other things, on the total power requirement.

Each power converter 1, 2 has a conventional three-phase two-level topology with a series of semiconductor power switching devices fully controlled and regulated using a pulse width modulation (PWM) switching strategy. However, in practice the power converters 1, 2 can have any suitable topology such as a neutral point clamped (NPC) topology or a flying capacitor (FC) multi-level topology.

A plurality of active inverters 18 supply power from the common dc link 16 to ac loads 20 such as ac motors. Each of the active inverters 18 has a similar three-phase two level topology to the power converters 1, 2 with a series of semiconductor switching devices fully controlled and regulated using a PWM switching strategy. However, in practice, the active inverters 18 can have any suitable topology as discussed above for the power converters 1, 2. Although only two active inverters 18 and associated ac loads 20 are illustrated, it should be understood that any suitable number active inverters 18 and ac loads 20 could be provided.

Due to differing component tolerances and other factors, the power converters 1, 2 may not be identical and this can present operational difficulties when they are connected in parallel, in particular with regard to current sharing and voltage regulation. In order to mitigate these difficulties, it is necessary to provide for suitable current sharing between the individual power converters 1, 2 to optimise the power distribution amongst the power converters 1, 2. As indicated above, this can be achieved by modifying the output voltage droop characteristics of the power converters 1, 2 as well as by synchronising the PWM strategies, and in particular the PWM command signals, of the individual power converters 1, 2.

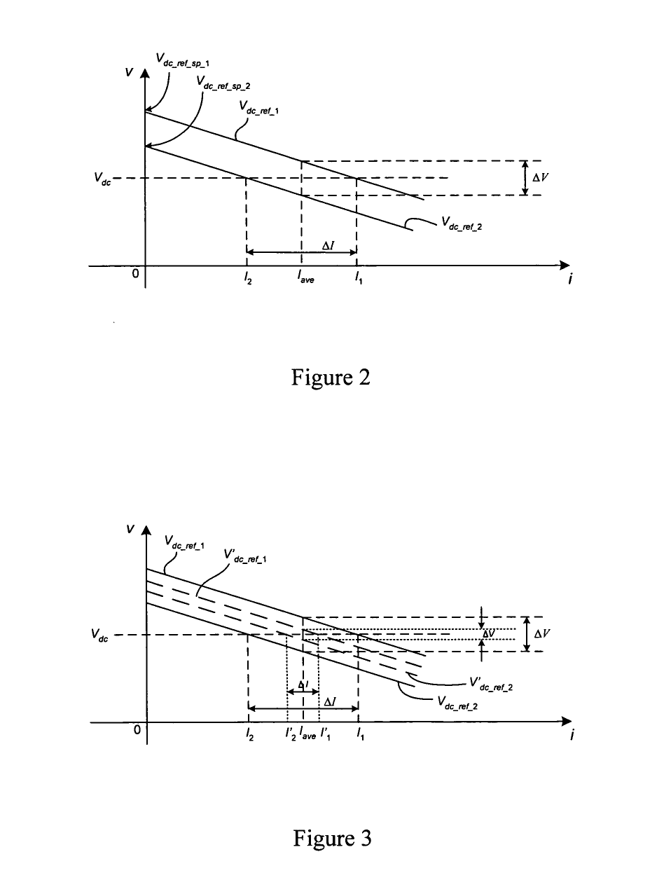

FIG. 2 illustrates one example of the load regulation characteristics of the parallel-connected power converters 1, 2 of FIG. 1. In this example, the dc link reference voltage set-point values V_{dc}_{_{—}}_{ref}_{_{—}}ₛₚ_{_{—}}₁ and V_{dc}_{_{—}}_{ref}_{_{—}}ₛₚ_{_{—}}₂ (i.e. the dc link reference voltages V_{dc}_{_{—}}_{ref}_{_{—}}₁ and V_{dc}_{_{—}}_{ref}_{_{—}}₂ at no load) are different and the droop rates of the two power converters 1, 2 are the same. It should, however, be appreciated that the dc link reference voltage set-point values V_{dc}_{_{—}}_{ref}_{_{—}}ₛₚ_{_{—}}₁ and V_{dc}_{_{—}}_{ref}_{_{—}}ₛₚ_{_{—}}₂ and/or the droop rates of the two power converters 1, 2 can be the same or different.

The dc link reference voltage of each power converter is determined in accordance with the following equation:

V_{dc}_{_{—}}_{ref}_{_{—}}ₙ=V_{dc}_{_{—}}_{ref}_{_{—}}ₛₚ_{_{—}}ₙ−KₙIₙ [Equation 1]

where V_{dc}_{_{—}}_{ref}_{_{—}}ₛₚ_{_{—}}ₙ is the dc link reference voltage set-point value for each power converter n, Kₙ is the droop rate of each power converter n and Iₙ is the output current of each power converter n.

It will be readily appreciated from FIG. 2 that there is a difference ΔI between the output currents I₁ and I₂ of the two parallel-connected power converters 1, 2 illustrated in FIG. 1 for the same dc link voltage (i.e. output voltage) V_{dc} and that there is a difference ΔV between the dc link voltages of the two power converters 1, 2 for the same output current Iₐᵥₑ. It will be appreciated from FIG. 2 that the output current Iₐᵥₑ is the average of the output currents I₁ and I₂ of the two power converters 1, 2 for the same dc link voltage V_{dc}.

Embodiments of the present invention provide a control methodology for modifying the output voltage droop characteristic of each of the power converters 1, 2 to reduce both the difference ΔI in the output currents I₁ and I₂ of the two power converters 1, 2 for a given dc link voltage V_{dc} and the difference ΔV between the dc link voltages of the two power converters 1, 2 for the same output current Iₐᵥₑ. The methodology thus improves both the current sharing performance and the voltage regulation accuracy of the parallel-connected power converters 1, 2.

In more detail, the dc link reference voltage V_{dc}_{_{—}}_{ref}_{_{—}}ₙ of each power converter n is independently variable. A suitable droop controller is provided for this purpose, as will be described later in this specification. Specifically, the dc link reference voltage V_{dc}_{_{—}}_{ref}_{_{—}}ₙ of each power converter is varied based on the average of the output currents of the plurality of parallel-connected power converters Iₐᵥₑ and the output current Iₙ of each respective power converter n.

FIG. 3 illustrates one example of possible modified load regulation characteristics for the two parallel-connected power converters 1, 2 illustrated in FIG. 1. Specifically, the output voltage droop characteristic of each of the parallel-connected power converters 1, 2 is modified by varying the dc link reference voltage V_{dc}_{_{—}}_{ref}_{_{—}}₁ and V_{dc}_{_{—}}_{ref}_{_{—}}₂ of each power converter 1, 2. In accordance with embodiments of the invention, the dc link reference voltage V_{dc}_{_{—}}_{ref}_{_{—}}₁ and V_{dc}_{_{—}}_{ref}_{_{—}}₂ of each power converter is varied based on the average of the output currents of the plurality of parallel-connected power converters Iₐᵥₑ and the output current I₁ and I₂ of each respective power converter 1, 2. In more general terms, the modified dc link reference voltage V′_{dc}_{_{—}}_{ref}_{_{—}}ₙ of each power converter n is determined in accordance with the following equation:

V′_{dc}_{_{—}}_{ref}_{_{—}}ₙ=V_{dc}_{_{—}}_{ref}_{_{—}}ₛₚ_{_{—}}ₙ−KₙIₙ+k′(Iₐᵥₑ−Iₙ) [Equation 2]

where (Iₐᵥₑ−Iₙ) is the error between the average of the output currents of the plurality of parallel-connected power converters and the output current of the power converter n and k′ is an offset adjustment value.

As a result of the use of the control methodology defined by equation 2, it will be seen in FIG. 3 that the modified dc link reference voltage V′_{dc}_{_{—}}_{ref}_{_{—}}₁ of the first power converter 1 is reduced relative to the original dc link reference voltage V_{dc}_{_{—}}_{ref}_{_{—}}₁ and that the modified dc link reference voltage V′_{dc}_{_{—}}_{ref}_{_{—}}₂ of the second power converter 2 is increased relative to the original dc link reference voltage V_{dc}_{_{—}}_{ref}_{_{—}}₂, thereby modifying the output voltage droop characteristics of both power converters 1, 2. As a result, there is a decrease in the difference ΔI between the output currents I₁ and I₂ of both power converters 1, 2 for the same dc link voltage V_{dc} and a decrease in the difference ΔV between the dc link voltages of the two power converters 1, 2 for the same output current Iₐᵥₑ. Both the current sharing performance and the voltage regulation performance of the power converters 1, 2 are thus improved by utilising the control methodology according to embodiments of the present invention.

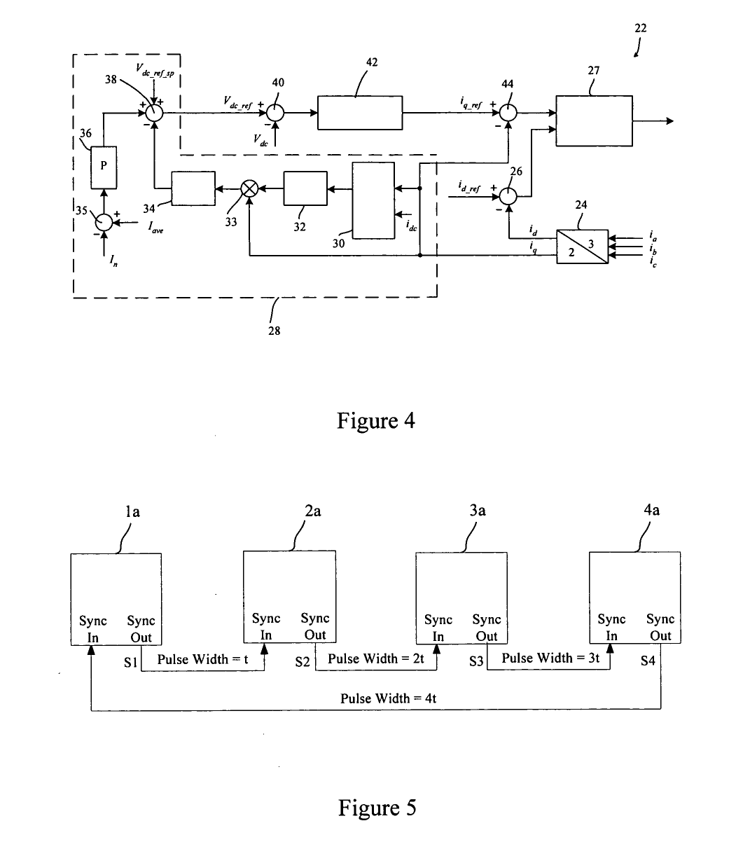

FIG. 4 is a schematic illustration of one possible embodiment of a controller 22 for use with at least one, and preferably both, of the power converters 1, 2 illustrated in FIG. 1 which implements the control methodology outlined above.

The controller 22 is operable to initially measure the instantaneous three-phase currents iₐ, i_{b}, and i_{c} of each power converter 1, 2, for example using suitable current sensors. The controller 22 includes a Forward Park transformation block 24 which transforms the measured three phase currents iₐ, i_{b}, and i_{c} from the stationary reference frame into the rotating reference frame to provide amplitude values of the reactive current i_{d} and active current i_{q}. The transformation equations implemented by the Forward Park transformation block 24 are as follows:

$$\begin{matrix}{i}_{d} = \frac{2}{3} \times ( {I}_{a} sin ( ω t ) + {I}_{b} sin ( ω t - 120 ° ) + {I}_{c} sin ( ω t + 120 ° ) ) & [ Equation 3 ] \\ {i}_{q} = \frac{2}{3} \times ( {I}_{a} cos ( ω t ) + {I}_{b} cos ( ω t - 120 ° ) + {I}_{c} cos ( ω t + 120 ° ) ) & [ Equation 4 ]\end{matrix}$$

where Iₐ, I_{b} and I_{c} are rms values of the measured instantaneous three-phase currents iₐ, i_{b} and i_{c} of each power converter and ω is the rotation speed (rad/s) of the rotating frame.

The controller 22 is operable to compare the reactive current i_{d} determined by the Forward Park transformation block 24 with the desired reactive current reference value i_{d}_{_{—}}_{ref} by subtracting the reactive current i_{d} from the desired reactive current reference value i_{d}_{_{—}}_{ref} at calculation block 26. The output from the calculation block 26 is fed to a current controller 27. In some embodiments, the desired reactive current reference value i_{d}_{_{—}}_{ref} may be zero but other values are, of course, possible and entirely within the scope of the claimed invention.

The dc link current i_{dc} flowing through the common dc link 16 is measured and is sent to a droop controller 28 which may form part of the controller 22 and which is operable to determine the output voltage droop characteristic of its respective power converter 1, 2. The output voltage droop characteristic of each power converter 1, 2 is defined by a droop rate and a droop sign, positive or negative, applied to the droop rate. In accordance with embodiments of the invention, the droop controller 28 is operable (at block 30) to determine whether a positive or negative droop sign should be applied to the droop rate (set by block 32). To do this, the droop controller 28 determines the direction of flow of the dc link current i_{dc} and determines the droop sign based on the direction of current flow through the common dc link 16. The direction of current flow is indicative of the direction of power flow through each power converter 1, 2. In some embodiments, when each power converter 1, 2 operates as a rectifier (when power is supplied to the common dc link 16 in power generation applications), the droop sign is positive. In other embodiments, when each power converter 1, 2 operates as an inverter (when power is supplied from the common dc link 16 in motoring applications), the droop sign is negative.

The product of the active current i_{q} (as determined by the Forward Park transformation block 24) and signed droop rate, performed at calculation block 33, is sent to a low pass filter 34 which eliminates any high frequency noise.

The droop controller 28 is operable to modify the output voltage droop characteristic of its respective power converter n, as generally discussed above with respect to FIGS. 2 and 3, by varying the dc link reference voltage V_{dc}_{_{—}}_{ref}_{_{—}}ₙ of the power converter. The average of the output currents of the plurality of parallel-connected power converters Iₐᵥₑ is determined by the droop controller 28 in accordance with the following equation:

$${I}_{ave} = \frac{1}{N} {\sum }_{n = 1}^{N} {I}_{n} \qquad [ Equation 5 ]$$

where N is the total number of the parallel-connected power converters and Iₙ is the rms value of the output current of each power converter n. Iₙ and Iₐᵥₑ must comply with the reference frame used by the controller 22 and may, therefore, need to be modified accordingly. In this example, the controller 22 uses the rotating reference frame and, hence, Iₙ and Iₐᵥₑ are transformed from the stationary reference frame into the rotating reference frame before Iₙ and Iₐᵥₑ are inputted into the calculation block 35. In alternative embodiments in which the controller 22 uses the three-phase stationary reference frame, Iₙ and Iₐᵥₑ may be the three-phase currents and their average, respectively.

In accordance with equation 2, the rms value of the output current Iₙ of each power converter 10 is subtracted from the average of the output currents at calculation block 35 and the resultant error is sent to a proportional controller 36 where it is modified in accordance with the offset adjustment value k′. The output of the proportional controller 36, which it will be clearly understood is based on the output current Iₙ, and the average of the output currents Iₐᵥₑ, is then used to modify the dc link reference voltage V_{dc}_{_{—}}_{ref}_{_{—}}ₙ at the calculation block 38. The signed droop rate and the modified dc link reference voltage set-point V_{dc}_{_{—}}_{ref}_{_{—}}ₛₚ are also taken into account by the calculation block 38 to provide the adaptively controlled dc link reference voltage V′_{dc}_{_{—}}_{ref}, generally in accordance with equation 2.

The error between the modified dc link reference voltage V′_{dc}_{_{—}}_{ref} and the measured dc link voltage V_{dc} is determined at the calculation block 40 and any resultant error is used as an input for a dc voltage controller 42 which is preferably a proportional-integral (PI) controller. The output of the dc voltage controller 42 is used to determine the active current reference i_{q}_{_{—}}_{ref}. Finally, the active current i_{q}, determined as aforesaid by the Forward Park transformation block 24, is subtracted, at the calculation block 44, from the active current reference i_{q}_{_{—}}_{ref}.

The error between the determined active current i_{q} and the active current reference i_{g}_{_{—}}_{ref} is fed to the current controller 27 along with the error between the determined reactive current i_{d} and the reactive current reference i_{d}_{_{—}}_{ref} as aforesaid, and the current controller 27 generates suitable PWM command signals to control each power converter 1, 2, for example by driving insulated gate bipolar transistors (IGBTs). Each controller 22 operates continuously and in real-time to provide for the active control of its associated power converter 1, 2 and, in particular, to provide for the active control of the output voltage droop characteristic of its associated power converter 1, 2. Both the current sharing performance and voltage regulation performance are thus improved.

Embodiments of the invention advantageously also provide for synchronisation of any number of parallel-connected power converters 1-N, since even a small phase difference between the power converters can cause an unwanted circulating current, especially under light load. Synchronisation of the power converters is achieved in the following manner.

The power converters 1-N are connected together to form a cascaded array. More particularly, each power converter includes a controller having an input for receiving a synchronisation signal from the controller of a preceding power converter in the array and an output for transmitting a synchronisation signal to the controller of a succeeding power converter in the array. The controller of the last power converter in the array transmits a synchronisation signal to the controller of the first power converter in the array to complete the connection and form a “closed loop”.

A cascaded array of four controllers 1a, 2a, 3a, 4a associated with a cascaded array of four parallel-connected power converters is shown schematically in FIG. 5. The input and output of each controller can be fibre optic channels so that the synchronisation signals are transmitted as optic signals through fibre optic cables, for example. Other means of transmitting the synchronisation signals, such as electrical or radio frequency (RF) signalling, can be used.

Each controller 1a, 2a, 3a, 4a is arranged to transmit a synchronisation signal consisting of a series of digital time pulses having states 0 and 1. The pulse period (i.e. the time between the falling edges of successive time pulses) can be measured by each controller and the pulse width of the time pulses (i.e. the period of time during which state 1 applies) can be used to provide information about the position the controller that transmits the synchronisation signal has within the array. The way in which each controller 1a, 2a, 3a, 4a, and hence its associated power converter, is allocated a role as a “master” or “slave” is described in more detail below with continued reference to FIG. 5.

In a situation where all four of the power converters in the array are connected in sequence and operating normally, the controller 1a of the first power converter may be the “master” controller and the controllers 2a, 3a, 4a of the second, third and fourth power converters may be the “slave” controllers. In this example, the controller la of the first power converter outputs to the controller 2a of the second power converter a first synchronisation signal S1 having a pulse width t. The controller 2a of the second power converter receives the first synchronisation signal S1 having a pulse width t and identifies its position as the second power converter in the array based on the pulse width t of the first synchronisation signal S1.

The controller 2a of the second power converter outputs a second synchronisation signal S2 having a pulse width 2t. The controller 3a of the third power converter receives the second synchronisation signal S2 having a pulse width 2t and identifies its position as the third power converter in the array based on the pulse width 2t of the second synchronisation signal S2.

The controller 3a of the third power converter outputs a third synchronisation signal S3 having a pulse width 3t. The controller 4a of the fourth power converter receives the third synchronisation signal S3 having a pulse width 3t and identifies its position as the fourth power converter in the array based on the pulse width 3t of the third synchronisation signal S3.

The controller 4a of the fourth power converter outputs a fourth synchronisation signal S4 having a pulse width 4t. The controller 1a of the first power converter receives the fourth synchronisation signal S4 of pulse width 4t which confirms its role as a “master” controller and its operation thus remains unchanged.

The controllers 1a, 2a, 3a, 4a of the parallel-connected power converters, and hence the power converters themselves, are determined to be a “master” or a “slave” depending on when they come on-line. The controller of the power converter in the array that is the first to come on-line preferably assumes a role as a “master” controller and takes a position as the first controller in the array. Any controller that receives a synchronisation signal when its power converter comes on-line will preferably assume a role as a “slave” controller. Any “slave” controller that fails to receive a synchronisation signal for any reason (i.e. the immediately preceding controller in the array goes off-line or the synchronisation signal is disrupted) may assume a role as a “master” controller.

The cascaded array of power converters functions normally until one of the power converters goes off-line or one of the synchronisation signals is otherwise disrupted. For example, if the first power converter goes off-line or the first synchronisation signal S1 is disrupted, the controller 2a of the second power converter no longer receives a synchronisation signal. The controller 2a of the second power converter thus assumes the role of the “master” controller and takes the first position in the array. The controller 2a now outputs a first synchronisation signal S1 having a pulse width t. The controller 3a of the third power converter receives the first synchronisation signal S1 of pulse width t and takes a role as a “slave” controller because it is receiving a synchronisation signal, but now takes the second position in the array.

The controller 3a of the third power converter now outputs a second synchronisation signal S2 having a pulse width 2t. The controller 4a of the fourth power converter receives the second synchronisation signal S2 of pulse width 2t and takes a role as a “slave” controller because it is receiving a synchronisation signal, but now takes the third position in the array.

The controller 4a of the fourth power converter now outputs a third synchronisation signal S3 having a pulse width 3t. When the first power converter comes back on-line, the controller 1a of the first power converter receives the third synchronisation signal S3 and assumes a role as a “slave” power converter because it is receiving a synchronisation signal. The controller 1a, and hence the first power converter, thus takes the fourth position in the array.

The controller 1a of the first power converter outputs a fourth synchronisation signal S4 having a pulse width 4t. The controller 2a of the second power converter receives the fourth synchronisation signal S4 which confirms its role as a “master” power converter and its operation remains unchanged.

It will be appreciated from the foregoing that synchronisation of the parallel-connected power converters can be maintained, and that the power converters can continue to operate effectively, in the event of a fault occurring in any one or more of the power converters. Reliability is thus significantly improved when the parallel-connected power converters operate as a cascaded array.

Although embodiments of the invention have been described in the preceding paragraphs with reference to various examples, it should be understood that various modifications may be made to those examples without departing from the scope of the present invention, as claimed.

For example, the output voltage droop characteristic of only one of the power converters 1, 2 could be modified by varying the dc link reference voltage V_{dc}_{_{—}}_{ref} of the respective power converter 1, 2 based on the average of the output currents of the plurality of parallel-connected power converters Iₐᵥₑ and the output current Iₙ of the respective one of the power converters 1, 2. The methodology may be employed with any number of power converters connected in parallel, whether they operate as active rectifiers and/or active inverters.

Although the droop rates of the power converters 1, 2 are shown to be the same as each other in FIGS. 2 and 3, it should be understood that the methodology described above is equally applicable when the droop rates of parallel-connected power converters are different.

1. A method for controlling a plurality of power converters connected in parallel between an ac arrangement and a common dc link, each of the power converters operating in accordance with a pulse width modulation (PWM) strategy and having an independently variable dc link reference voltage, the method comprising modifying an output voltage droop characteristic of at least one of the plurality of parallel-connected power converters by varying the dc link reference voltage of the at least one power converter based on the output current of the at least one power converter and the average of the output currents of the plurality of power converters.

2. The method of claim 1, wherein the method comprises modifying the output voltage droop characteristic of each of the plurality of parallel-connected power converters by varying the dc link reference voltage of each power converter based on the output current of each respective power converter and the average of the output currents of the plurality of power converters.

3. The method of claim 1, wherein the method comprises continuously measuring the output current of the or each power converter and continuously determining the average of the output currents of the plurality of power converters to thereby actively modify the output voltage droop characteristic of the or each power converter by varying the dc link reference voltage of the or each power converter.

4. The method of claim 1, wherein the method comprises modifying the output voltage droop characteristic of a first power converter by decreasing the dc link reference voltage of the first power converter and modifying the output voltage droop characteristic of a second power converter by increasing the dc link reference voltage of the second power converter.

5. The method of claim 1, wherein the method comprises varying the dc link reference voltage of the or each power converter based on the error between the average of the output currents of the plurality of power converters and the rms output current of the or each respective power converter.

6. The method of claim 1, wherein the output voltage droop characteristic of the or each power converter is defined by a droop rate and a droop sign applied to the droop rate, the step of controlling the output voltage droop characteristic of at least one of the plurality of power converters further comprising determining the droop sign.

7. The method of claim 6, wherein the step of determining the droop sign comprises determining the direction of current flow through the common dc link.

8. The method of claim 1, wherein the method comprises synchronising the parallel-connected power converters by providing each of the power converters with a synchronisation signal.

9. The method of claim 1, in which the PWM strategy of each power converter is defined by an independent voltage carrier signal and an independently controllable modulating sinusoidal voltage signal which are used to generate a PWM command signal for each PWM strategy, wherein the voltage carrier signals of the PWM strategies have the same switching period and wherein any desynchronisation of the PWM command signals causes an unwanted circulating current to flow between the power converters, the method comprising providing the independently controllable modulating sinusoidal voltage signal of the PWM strategy of at least one of the power converters with a dc voltage offset to modify the PWM command signal of the at least one power converter and thereby increase the synchronisation of the PWM command signals so that the magnitude of any unwanted circulating current is reduced.

10. A plurality of power converters connected in parallel between an ac arrangement and a common dc link, each of the power converters operating in accordance with a pulse width modulation (PWM) strategy and having an individually variable dc link reference voltage, at least one of the power converters including a droop controller for controlling the output voltage droop characteristic of the power converter, wherein the droop controller is operable to modify the output voltage droop characteristic by varying the dc link reference voltage of the at least one power converter based on the output current of the at least one power converter and the average of the output currents of the plurality of power converters.

11. The plurality of parallel-connected power converters of claim 10, wherein each of the power converters includes a droop controller and each droop controller is operable to modify the output voltage droop characteristic of its respective power converter by varying the dc link reference voltage of the power converter based on the output current of the power converter and the average of the output currents of the plurality of power converters.

12. The plurality of parallel-connected power converters of claim 10, wherein the or each droop controller is operable to actively vary the dc link reference voltage of its respective power converter based on continuous determinations of the output current of its respective power converter and the average of the output currents of the plurality of power converters.

13. The plurality of parallel-connected power converters of claims 10, wherein the output voltage droop characteristic of the or each power converter is defined by a droop rate and a droop sign applied to the droop rate, the or each droop controller being operable to control the output voltage droop characteristic of its respective power converter by determining the droop sign.

14. The plurality of parallel-connected power converters of claim 13, wherein the or each droop controller is operable to determine the droop sign by determining the direction of current flow through the common dc link.

15. The plurality of parallel-connected power converters of claims 10, wherein some or all of the parallel-connected power converters are operable as active rectifiers or active inverters.
